(19) United States
(12) Patent Application Publication
(10) Pub. No.: US 2007/0269186 A1
(43) Pub. Date: Nov. 22, 2007

(54) Recording and replay device

(75) Inventor: Hirofumi Tani, Osaka (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: FUNAI ELECTRIC CO., LTD., Osaka (JP)

(21) Appl. No.: 11/802,342

(22) Filed: May 22, 2007

(30) Foreign Application Priority Data
May 22, 2006 (JP) 2006-141787

(51) Int. Cl. H04N 7/00

(52) U.S. Cl. 386/95

(57) ABSTRACT

This recording and replay device includes a replay means which reads in and replays binary data from a medium upon which a binary file which includes binary data and index data is stored. This medium also stores a table in which representative time points and second addresses are held in mutual correspondence. Moreover, this recording and replay device includes an address detection means which, when a replay elapsed time is designated, refers to this table, and extracts that one of the second addresses which corresponds to that one of the representative time points which, while being before the elapsed time for replay, is closest thereto. And this address detection means searches sequentially through the index data from the second address which has been extracted, and detects that one of the first addresses which corresponds to the elapsed time for replay.

### CROSS REFERENCE

This Nonprovisional application claims priority under 35 U.S.C. §119(a) on Patent Application No. 2006-141787 filed in Japan on May 22, 2006, the entire contents of which are hereby incorporated by reference.

### BACKGROUND OF THE INVENTION

The present invention relates to a recording and replay device which is endowed with a function of designation and replay by time point.

In the prior art, a recording and replay device has been implemented which replays a binary file recorded upon a medium in which the storage position of the relevant data is specified by an address. Here a “medium” means, for example, a hard disk. The binary file may be, for example, an AVI (Audio Video Interleave) file. Such a binary file includes binary data and index data. The term “binary data” denotes data which has a format other than character data, and may be data such as video or audio or the like. And the index data is data for performing storage management of this binary data.

With a prior art type recording and replay device, a binary file may be replayed from its head end, or a certain time point partway there along may be designated, and replay therefrom may be performed in order to view some desired scene (this is also termed “time searching”). In this time point designation and replay, a replay time point within the entire replay time period is designated as the elapsed time for replay, and replay is performed by extraction from partway through the binary data.

With such a recording and replay device according to the prior art, when the user has designated an elapsed time for replay, the address of the binary data which corresponds to this replay elapsed time is detected by searching the index data sequentially from its head end. And, with such a recording and replay device according to the prior art, binary data is then replayed from the address of the binary data which has thus been detected. By doing this, replay is started from the designated time point, so that the user is able to view from the desired scene.

It should be understood that, in Japanese Laid-Open Patent Publication Heisei 11-260039, there is proposed a recording and replay device which edits the index data when the binary data has been edited.

However, with such a prior art recording and replay device as described above, a long time period is required for the detection of the address of the binary data. The main cause for this is the sequential structure of the index data. For example, in the index data of an AVI file, a correspondence relationship between the replay times for the binary data and the storage positions of the binary data may be stored sequentially according to time series of the replay time. Due to this, when detecting the address of the binary data which corresponds to some replay elapsed time, in a prior art type recording and replay device of the above described type, it is necessary to search through this index data sequentially from its head end. Moreover, the data amount of the index data for the AVI file may be large, such as several tens of MB (megabytes).

Due to this, with a recording and-replay device of a prior lo art type such as that described above, a long time period is required from specification of a replay elapsed time by the user, until time point designation and replay can be started. Accordingly, the user is forced to wait during this long time period. Thus, with such a recording and replay device of a prior art type such as that described above, there has been the problem that the convenience of use from the point of view of the user has been bad.

The object of the present invention is to provide a recording and replay device, in which the time period required from specification of a replay elapsed time until time period designation and the start of replay is shortened.

### SUMMARY OF THE INVENTION

The recording and replay device according to the present invention includes a replay means which reads in and replays binary data from a medium upon which is stored a binary file which includes binary data in which video or audio is recorded, and index data. This medium is a medium in which the storage positions of data are specified by addresses. And, in this index data, correspondence relationships between replay times of the binary data, and first addresses which specify storage positions of the binary data, are recorded sequentially according to time series of the replay time. Moreover, upon this medium, there is also stored a table in which representative time points which are determined in advance within the entire replay time of the binary data, and second addresses which specify the storage positions within the index data at which binary data corresponding to the representative time points is stored, are stored in mutual correspondence. With this structure, this medium may be, for example, a hard disk, an optical disk, or a semiconductor memory. And the binary file may be, for example, an AVI (Audio Video Interleave) file. By the replay time is meant the time period during replay from the head end of the binary data, until the current replay position.

Furthermore, this recording and replay device includes an address detection means which, when during replay of the binary data one replay time point within the entire replay time is designated as an elapsed time for replay, refers to the table, and extracts that one of the second addresses which corresponds to that one of the representative time points which, while being before the elapsed time for replay, is closest thereto.

And the address detection means executes the following operations sequentially.

(1) It searches sequentially through the index data from the second address which has been extracted, and detects that one of the first addresses which corresponds to the elapsed time for replay; and

(2) It commands the replay means to read and replay the binary data from the first address which has been detected.

Due to the above, in (1) described above, this recording and replay device does not necessarily search through the index data sequentially from its head end, but rather searches sequentially from the index data which is present at the second address which has been extracted. And this recording and replay device detects that one of the first addresses which corresponds to the replay elapsed time.

### BRIEF DESCRIPTION OF THE DRAWINGS

FIG. 1 is a block diagram showing the main structure of an optical disk device which is an embodiment of the present invention;

FIG. 2 is a figure showing an example of a portion of the recording region of an optical disk 100;

FIG. 3 is a figure showing the data structure of an AVI file;

FIG. 4 is a figure showing the contents of index data recorded for this AVI file;

FIG. 5 is a flow chart showing an operation performed by a control unit of this optical disk device according to an embodiment of the present invention, when recording of an AVI file upon an optical disk has been completed;

FIG. 6 is a figure showing the data structure of a MAP file;

FIG. 7 is a figure showing the recording region of an optical disk 100; and

FIG. 8 is a flow chart showing the operation performed by a control unit of this optical disk device according to an embodiment of the present invention, when an AVI file upon an optical disk has been designated.

### DETAILED DESCRIPTION OF THE INVENTION

In the following, an optical disk device which is an embodiment of the present invention will be explained with reference to the drawings.

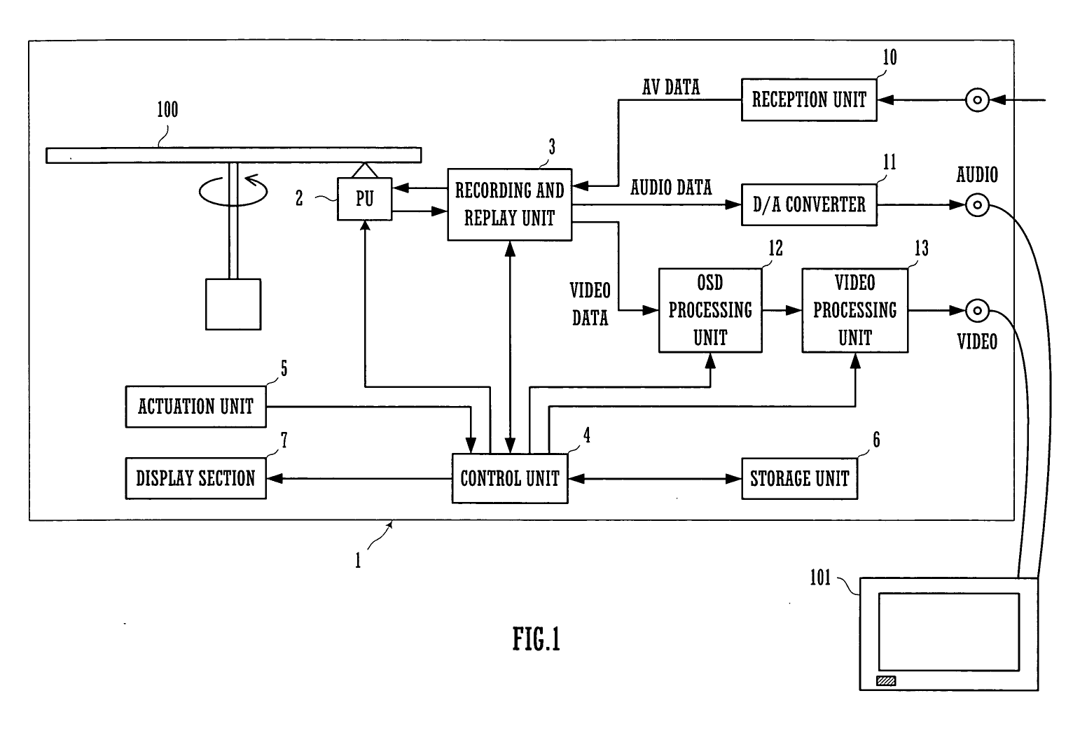

FIG. 1 is a block diagram showing the main structure of an optical disk device which is an embodiment of the present invention. This optical disk device 1 comprises: a control unit 4 which controls the operation of the various sections of the optical disk device 1; a pickup head 2 (hereinafter termed the PU head 2) which performs recording of data upon the optical disk 100 and reading of data therefrom; a recording and replay unit 3 such as an RF amp or the like; an actuation unit 5 which receives input actuation from the user; a display section 7 which displays information; a storage unit 6 which stores data; a D/A converter 11 which converts audio data to an analog replay audio signal; an video processing unit 13 which converts video data to an analog replay video signal; and a reception unit which acquires data by receiving TV broadcast signals and the like.

This optical disk device 1 is a so called DVD recorder. The optical disk 100 may be, for example, a CD-R, a CD-RW, a DVD-R, a DVD+R, a DVD-RAM, a DVD-RW, a DVD+RW, or the like.

The PU head 2 comprises a laser diode (LD), a collimator lens, a beam splitter, an objective lens, a photodetector, a thread motor, an actuator, and so on, none of which are shown in the figures.

This PU head 2 is fitted upon a shaft which extends along the radial direction of the optical disk 100, so as to shift freely thereupon. And the thread motor shifts the PU head 2 in the radial direction of the optical disk 100.

The LD is a light source which outputs laser light. The photodetector consists of a plurality of light reception elements, and detects light reflected from the optical disk 100. The light reception region of this photodetector may, for example, be divided into four almost equal portions, so that the photodetector consists of four light reception regions.

The objective lens adjusts the irradiation position of the laser light upon the optical disk 100. Furthermore, the actuator shifts the objective lens in the direction towards and away from the optical disk 100, and in the radial direction of the optical disk 100.

First, the operation during replay will be explained. The PU head 2 irradiates laser light of a certain reading power upon the optical disk 100, and detects the light reflected from the optical disk 100 with a photodetector. By doing this, the data recorded upon the optical disk 100 is optically read out.

The recording and replay unit 3 generates a RF signal based upon the outputs of the plurality of light reception elements in the PU head 2, and amplifies this RF signal. And the recording and replay unit 3 processes this RF signal and extracts and decodes the video data and the audio data therein. Here, in the case of an AVI file, the video data and the audio data which are extracted are encoded by Motion JPEG or the like. And the recording and replay unit 3 outputs the audio data to the D/A converter 11 and the video data to the video processing unit 13, while maintaining synchronization between these two data streams.

The D/A converter 11 converts this audio data which has thus been expanded into an analog replay audio signal, and outputs this replay audio signal to an external television 101.

And the video processing unit 13 converts the video data which has been inputted into an analog replay video signal, which it likewise outputs to the external television 101.

This television 101 is connected to the D/A converter 11 and the video processing unit 13. Thus, on this television 101, the user is able to view video based upon the replay video signal outputted from the video processing unit 13, and to listen to audio based upon the replay audio signal outputted from the D/A converter 11.

It should be understood that, if the television 101 is compatible with digital signals, the signals may be outputted just as they are to this television 101 without being converted into analog form.

Next, the operation during recording will be explained. A reception unit 10 is, for example, a tuner. This reception unit 10 extracts a TV broadcast signal upon a selected channel from an antenna which receives TV broadcasts and the like. And the reception unit 10 performs A/D conversion upon this TV broadcast signal and converts it into digital form, then outputting the result to the recording and replay unit 3. On the other hand, if contents such as the internet of a digital broadcast or the like is inputted as digital data, the reception unit 10 extracts data from the packets or the TV broadcast signal or the like. And the reception unit 10 outputs the result to the recording and replay unit 3.

And the recording and replay unit 3 encodes this data which has thus been inputted (for example by Motion JPEG) and outputs the resulting digital signal to the PU head 2.

Moreover, when this digital signal from the recording and replay unit 3 is inputted, the PU head 2 controls laser light of a certain recording power according to this digital signal, and irradiates this laser light upon the recording surface of the optical disk 100.

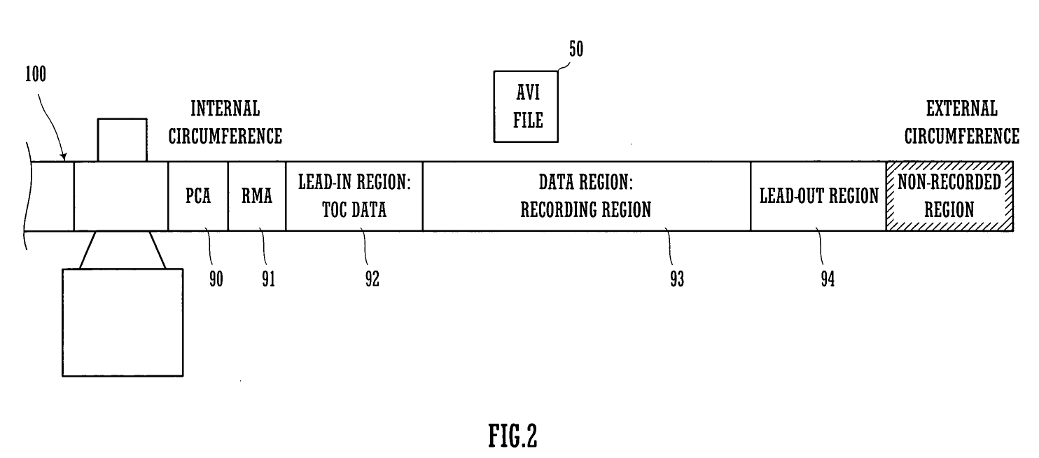

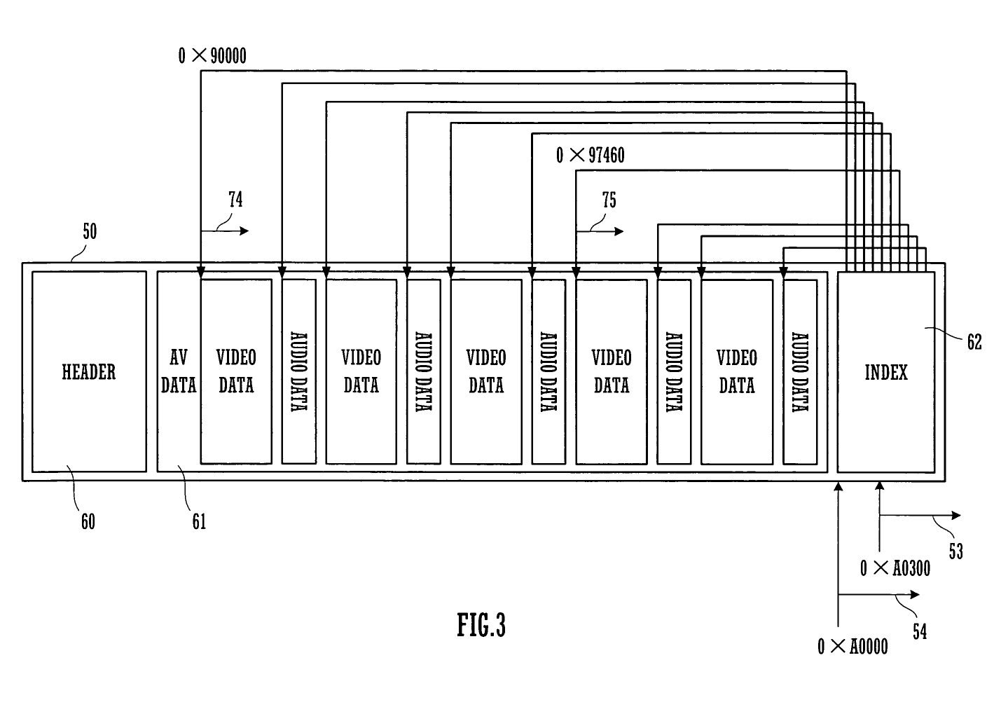

An AVI file 50 (which will be described hereinafter with reference to FIGS. 2 and 3), which is a binary file, may also be recorded upon the optical disk 100 by the operation described above.

The actuation unit 5 is a device for the user to input various types of command to the optical disk device 1. A plurality of keys are provided upon this actuation unit 5, including a replay key, a recording key, and a replay time point designation key. Commands which have been thus inputted to the optical disk device 1 are transmitted to the control unit 4.

The user designates a desired AVI file 50 which has been recorded upon the optical disk 100 with the replay key (as will be described hereinafter with reference to FIG. 2). Furthermore, the above described replay time point designation key is a key for designation of a time point for replay upon the optical disk 100. The user designates an elapsed time for replay with this replay time point designation key.

The storage unit 6 consists of, for example, a hard disk or an EEPROM. This storage unit 6 stores a main control program which specifies a control method for controlling the operation of the various sections of the optical disk device 1.

The display section 7 displays the current time, the setting state of the optical disk device 1, and the like.

The control unit 4 consists of, for example, a microcomputer. This control unit 4 controls the various sections of the optical disk device 1 according to commands which are inputted from the user. The control unit 4 includes a RAM which functions as a working space for holding data and the like processed by the above described control program.

Here, the PU head 2, the recording and replay unit 3, the D/A converter 11, the video processing unit 13, and the control unit 4 correspond to the “replay means” of the Claims. Furthermore, the PU head 2, the recording and replay unit 3, and the control unit 4 correspond to the “address detection means” of the Claims. Moreover, the PU head 2, the recording and replay unit 3, and the control unit 4 correspond to the “generation and recording means” of the Claims. And the optical disk 100 corresponds to the “medium” of the Claims.

FIG. 2 is a figure showing an example of a portion of the recording region upon the optical disk 100. From the inner circumference of this optical disk 100 towards its outer circumference, this recording region is divided into a PCA 90 (Power Calibration Area), a RMA (Recording Management Area) 91, a lead-in region 92, a data region 93, and a lead-out region 94. This optical disk 100 is a medium upon which the storage positions of data items are specified by addresses.

The PCA 90 is a region upon which calibration of the laser power is performed. And the RMA 91 is a region in which information which is necessary for the optical disk device 1 to perform recording management is recorded.

The lead-in region 92 is a region in which TOC data for the data which is recorded in the data region 93 upon the optical disk 100 is recorded. In this TOC data, there are included information as to whether or not the data which has been stored is finalized, the date upon which the data was stored, title information for the stored data, address information which specifies the position in which the data is stored upon the optical disk 100, and the like.

The data region 93 is a region in which the stored data is recorded. In the example shown in FIG. 2, an AVI file 50 is recorded in this region.

And the lead-out region 94 is a region which is created when the stored data is finalized.

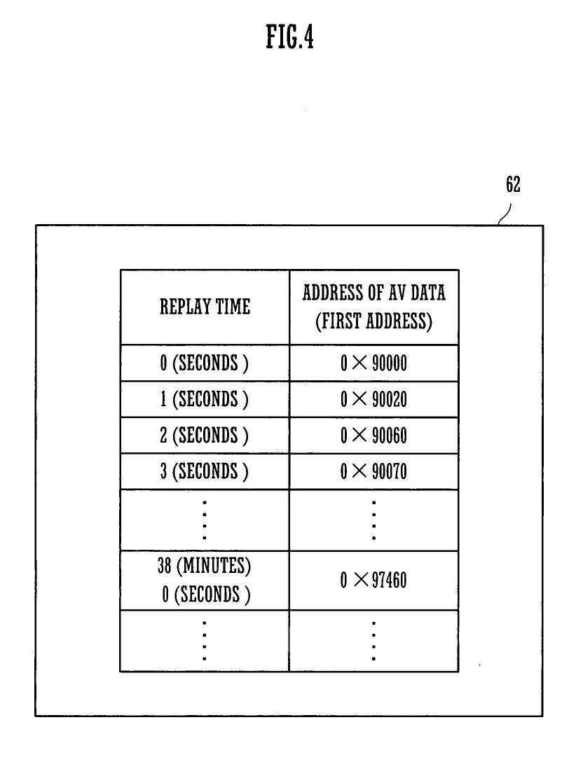

FIG. 3 is a figure showing the data structure of this AVI file 50. And FIG. 4 is a figure showing the contents written in the index data for this AVI file 50.

It should be understood that although, in this embodiment, the case is explained in which the binary file is an AVI file 50, this is not to be interpreted as being exclusive of some other type of file format.

As shown in FIG. 3, this AVI (Audio Video Interleave) file 50 is a file in the AVI format. This AVI file 50 consists of three sections: a header 60, AV data 61, and index data 62.

Information required for replay is stored in the header 60, such as the codec method by which the AVI file 50 is processed, the frame rate, and the like.

The AV data 61 consists of video data and audio data, arranged alternatingly. The amount of this AV data 61 is variable. The amount of audio data per one frame may be, for example, 4272 B (bytes). And the amount of video data per one frame may be, for example, 120 KB (kilobytes).

The index data 62 is data for storage management of the AV data. As shown in FIG. 4, in this index data 62, the time instants of replay of the AV data 61 and first addresses which specify the storage positions of the AV data 61 are recorded as a correspondence relationship sequentially according to the time series of the replay times. In other words, in this index data 62, correspondence relationships between replay times of the binary data, and first addresses which specify storage positions of the binary data, are recorded sequentially according to time series of the replay time. In more detail, as this correspondence relationship, addresses of the AV data 61 at predetermined steps of replay time are recorded in this index data 62 in sequence. In this embodiment, the predetermined replay time step is 1 second. The amount of this index data 62 is typically several tens of megabytes (MB).

It should be understood that by “replay time” is meant, during replay, the time period from the head end of the binary data until the current replay position.

Here, the optical disk device 1 can replay the AVI file 50 from its head end even without referring to the index data 62 (refer to the arrow sign 74 in FIG. 3). However, the optical disk device 1 cannot know the address of the AV data 61 for a particular replay time without referring to the index data 62. Due to this, the optical disk device 1 cannot perform replay time designation and replay, without such reference to the index data 62.

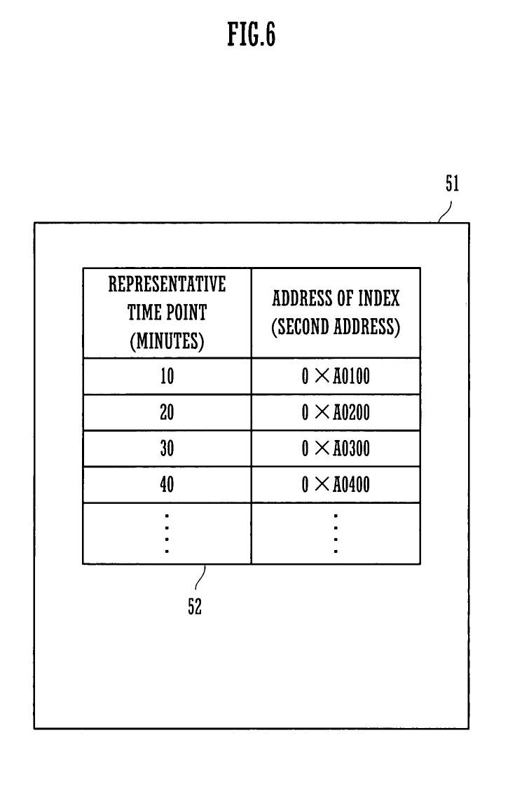

In the following, a first scenario in which a table 52 (described hereinafter with reference to FIG. 6) is recorded upon the optical disk 100, and a second scenario in which an AVI file 50 which is recorded upon the optical disk 100 is replayed, will be explained separately.

First, the first scenario will be explained.

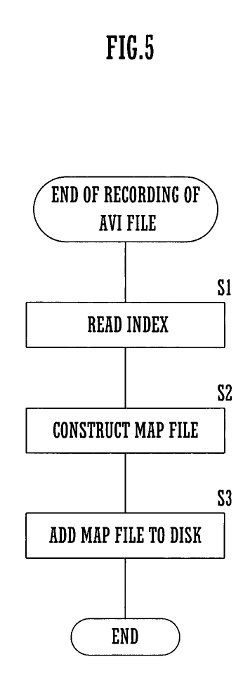

FIG. 5 is a flow chart showing the operation performed by the control unit of this optical disk device which is an embodiment of the present invention, when recording of the AVI file 50 itself upon the optical disk has been completed.

When the recording of the AVI file 50 itself upon the optical disk 100 has been completed, the control unit 4 reads the index data 62 in the AVI file 50, using the PU head 2 (a step S1). This index data 62 which has been read is inputted to the control unit 4 via the recording and replay unit 3.

Next, the control unit 4 constructs a MAP file 51 which includes a table 52, based upon the index data 62 which was read in during the step S1 (a step S2).

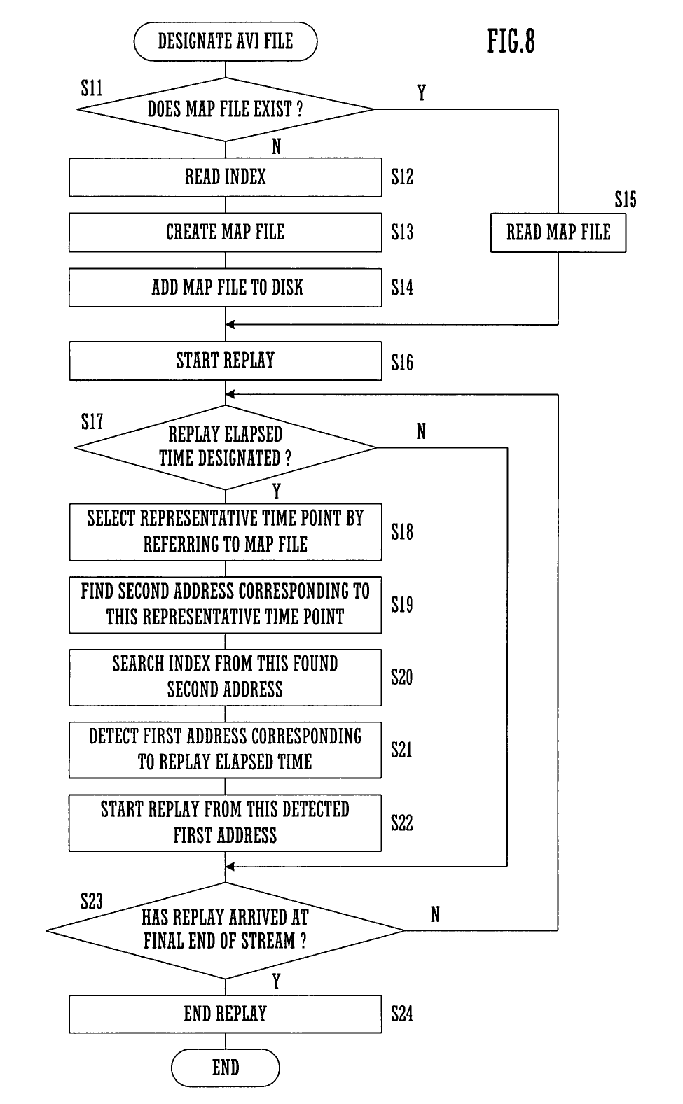

FIG. 6 is a figure showing the data structure of this MAP file. The table 52 is stored in the MAP file 51. This table 52 is information in which representative time points which are defined in advance within the entire replay time of the AV data 61, and second addresses which specify the storage positions within the index data 62 for the storage data at said representative time points, are stored in mutual correspondence. These representative time points will be explained in detail hereinafter with reference to the step S18 of FIG. 8.

It should be understood that, in FIG. 4 and FIG. 6, the notation “0X” which is prefixed before the four digit numerical values means that these numerical values are expressed in hexadecimal.

The control unit 4 then issues commands to the PU head 2, and thereby records the MAP file 51 in correspondence with the AVI file 50 upon the optical disk 100 (a step S3), and then this processing terminates.

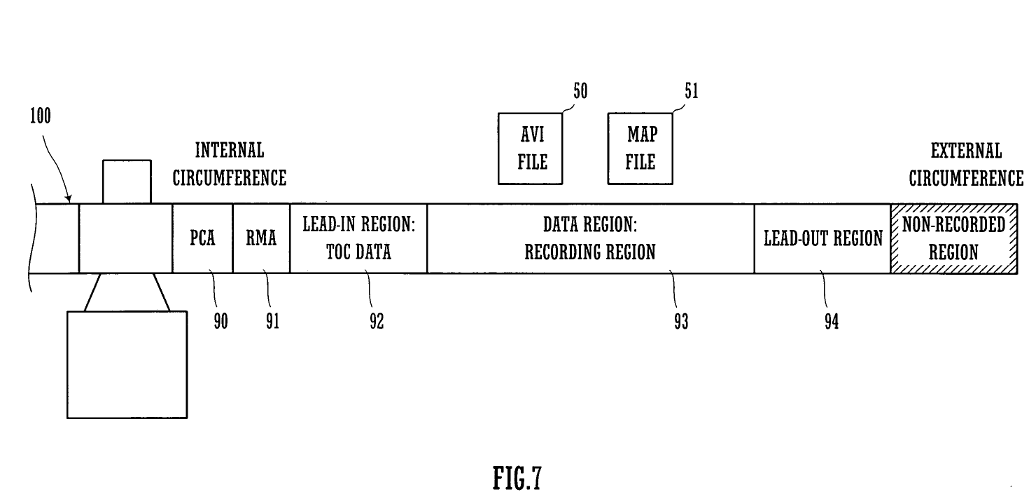

FIG. 7 is a figure showing the recording region of the optical disk 100. In this FIG. 7, a situation is shown in which an AVI file 50 and a MAP file 51 are recorded in the data region 93.

The relationship between the MAP file 51 and the AVI file 50 in the step S3 is established in order to make it easier to find the MAP file 51 in the step S11 of FIG. 8, as will be described hereinafter. For example, this correspondence may be set up by the method of using the same file name for the MAP file 51 and the AVI file 50, with only the extension being changed. Furthermore, the method may also be employed of storing the MAP file 51 and the AVI file 50 in the same directory.

Next, the second scenario will be explained.

FIG. 8 is a flow chart showing the operation performed by the control unit of this optical disk device which is an embodiment of the present invention, when an AVI file 50 upon the optical disk has been designated. This operation is performed when the user has designated, using the replay key, a desired AVI file 50 which has been recorded upon the optical disk 100.

First, the control unit 4 decides whether or not the above described MAP file 51 exists or not (a step S11). This decision is performed by searching for the MAP file 51 with the PU head 2. During this step S11, if the MAP file 51 and the AVI file 50 are set up in mutual correspondence, then it is easy to discover the MAP file 51. This is because, in this case, the control unit 4 need only search for that MAP file 51 which corresponds to the AVI file 50.

If in the step S11 it is decided that the MAP file 51 does not exist, then the control unit 4 reads the index data 62 within the AVI file 50 with the PU head 2 (a step S12). This processing is the same as that performed in the step S1 described above. And since, in the steps S12 through S14, while the AVI file 50 exists, the MAP file 51 does not exist, accordingly in this second scenario it is supposed that the MAP file 51 is to be created.

The control unit 4 creates (a step S13) a MAP file 51 which includes a table 52, based upon the index data 62 which was read in during the step S12. This processing is identical to that performed in the step S2 described above.

The control unit 4 then commands the PU head 2, and thereby records the MAP file 51 upon the optical disk 100 in correspondence with the AVI file 50 (a step S14). This processing is, similarly, identical to that performed in the step S3 described above.

It should be understood that, in this step S14, the control unit 4 stores the MAP file 51 which has been created in the step S13 in the storage unit 6, while also providing it for time point designation and replay, which are executed as will be described hereinafter.

On the other hand, if in the step S11 it is decided that the MAP file 51 actually does exist, then the control unit 4 reads the MAP file 51 with the PU head 2 (a step S15). Here, if in the steps S12 through S14 the MAP file 51 were to be created after designation of replay of the AVI file 50, then the time period which would be required from this designation until the replay is started would become long. Due to this, the MAP file 51 is created in advance, after the recording of the AVI file 50 has been completed (refer to FIG. 5). Accordingly, it is possible to enhance the convenience of use from the point of view of the user by yet a further level.

It should be understood that the point of providing the step S15 is that doing so makes it possible, when the replay elapsed time during replay has been designated, immediately to start the time point designation and replay. In the step S15, the control unit 4 stores the MAP file 51 which was read in during the step S15 in the storage unit 6, while also providing it for time point designation and replay, which are executed as will be described hereinafter.

After the step S14 or the step S15, the control unit 4 starts the replay operation (a step S16).

And, during replay (a step S23), the control unit 4 decides (a step S17) whether or not a replay elapsed time for the AV data 61 is being designated with the replay time point designation key. Here a scenario is supposed in which, in order to view some desired scene, the user designates a replay elapsed time with the replay time point designation key.

If, during replay, a replay elapsed time for the AV data 61 is not being designated with the replay time point designation key, then the control unit 4 terminates the replay operation (a step S24), and this processing terminates.

On the other hand if, during replay, a replay elapsed time for the AV data 61 is being designated with the replay time point designation key, then the control unit 4 refers to the table 52 stored in the MAP file which has been stored in the storage unit 6 as described above, and selects that representative time point which is before the replay elapsed time which has been designated and moreover is closest to that replay elapsed time (a step S18). For example, if the replay elapsed time which has been designated is 38 minutes 0 seconds, then the control unit 4 selects the representative time point of 30 minutes which is before 38 minutes 0 seconds and moreover is closest to 38 minutes 0 seconds (refer to FIG. 6).

Next, the control unit 4 seeks in the table 52 for the second address (address of index data 62) which corresponds to this representative time point (a step S19). For example, if the representative time point which has been selected in the step S18 is 30 minutes, then the control unit 4 searches out (i.e. extracts) from the table 52 the address “0XA0300” of the index data which corresponds to 30 minutes (refer to FIG. 6).

Next, the control unit 4 searches with the PU head 2 from the index data 62 which is present at this second address which has been found (a step S20). For example, if the second address which was found in the step S19 is “0XA0300”, then the control unit 4 searches with the PU head 2 from the index data 62 which is present at “0XA0300” (refer to the arrow sign 53 in FIG. 3).

And the control unit 4 detects, using the PU head 2, the first address which corresponds to the replay elapsed time (i.e. the address of the AV data 61) (refer to S21 and FIG. 3). For example, if the replay elapsed time which has been designated is 38 minutes, then the control unit 4 seeks the PU head 2 along from the index data 62 which is present at “0XA0300” (refer to the arrow sign 53 in FIG. 3), and detects the address “0X97460” of the AV data 61 which corresponds to the replay elapsed time of 38 minutes (refer to FIGS. 3 and 4).

And the control unit 4 commands the PU head 2 to read in and replay the AV data 61 from this first address which has thus been detected (a step S22). By doing this, the replay time point designation (also termed time searching) is started (refer to the arrow sign 75 in FIG. 3).

By the above, in the step S20 described above, the optical disk device 1 searches sequentially from the index data 62 which is present at the second address which has been found (refer to “0XA0300” and the arrow sign 53 in FIG. 3). On the other hand, with a prior art type recording and replay device, the index data 62 was searched sequentially by starting from its head end (refer to “0XA0000” and the arrow sign 54 in FIG. 3). Due to this, with this optical disk device 1, as compared with the case of a prior art type recording and replay device, it is possible to shorten the time period required for detection of the first address which corresponds to the replay elapsed time.

Accordingly, it is possible to shorten the time period which is required from when the replay elapsed time is designated, until the replay time point designation is started. Thus it is possible to enhance the convenience of use from the point of view of the user.

And, when the replay process arrives at the final end of the stream (a step S23), the control unit 4 terminates the replay operation (a step S24), and this processing terminates.

What is claimed is:

1. A recording and replay device in which a medium in which the storage position of data is specified by addresses may be loaded, wherein, upon said medium, there are stored:
a binary file which includes binary data in which video or audio is recorded, and index data in which correspondence relationships between replay times of said binary data, and first addresses which specify storage positions of said binary data, are recorded sequentially according to time series of said replay times; and
a table in which representative time points which are determined in advance within the entire replay time of said binary data, and second addresses which specify the storage positions within said index data at which binary data corresponding to said representative time points is stored, are stored in mutual correspondence;
and comprising:
a replay means which reads in and replays said binary data from said medium which is loaded into said recording and replay device; and
an address detection means which, when during replay of said binary data one replay time point within the entire replay time is designated as an elapsed time for replay, refers to said table, and extracts that one of said second addresses which corresponds to that one of said representative time points which, while being before said elapsed time for replay, is closest thereto;
and wherein said address detection means: searches sequentially through said index data from said second address which has been extracted, and detects that one of said first addresses which corresponds to said elapsed time for replay; and
commands said replay means to read and replay said binary data from said first address which has been detected.

2. A recording and replay device as described in claim 1, comprising a generation and recording means which generates said table based upon said index data, and moreover records said table which it has generated upon said medium.

3. A recording and replay device as described in claim 2, wherein said recording means records said table which it has generated upon said medium, after the recording of said binary file has been completed.

4. A recording and replay device as described in claim 2, wherein:
said generation and recording means records said table which it has generated upon said medium, in correspondence with said binary file;
and said address detection means, when during replay of said binary data one replay time point within the entire replay time is designated as an elapsed time for replay, refers to said table which is in correspondence with said binary file.
